(19) United States
(12) Patent Application Publication
(10) Pub. No.: US 2013/0157212 A1
(43) Pub. Date: Jun. 20, 2013

(54) METHOD FOR DETACHING A BONDED CONNECTION BY MEANS OF ELECTROMAGNETIC RADIATION

(71) Applicants: Raimund Hibst, Erbach (DE); Ralph G. Luthardt, Ulm (DE); Karl Stock, Ellwangen (DE); Heike Rudolph, Eurasburg (DE); Katharina Kuhn, Bibertal (DE)

(72) Inventors: Raimund Hibst, Erbach (DE); Ralph G. Luthardt, Ulm (DE); Karl Stock, Ellwangen (DE); Heike Rudolph, Eurasburg (DE); Katharina Kuhn, Bibertal (DE)

(21) Appl. No.: 13/703,041

(22) PCT Filed: Jun. 10, 2011
(86) PCT No.: PCT/DE11/01287

§ 371 Date: Mar. 11, 2013

(30) Foreign Application Priority Data
Jun. 10, 2010 (DE) 10 2010 023 394.3

(51) Int. Cl. A61C 7/02; A61C 5/04; A61C 5/08; A61C 13/15

(52) U.S. Cl. CPC A61C 7/023; A61C 19/004; A61C 5/04; A61C 5/08
USPC 433/3; 433/226; 433/24; 433/29

(57) ABSTRACT

The invention relates to a method for reversibly securing an attachment part to a base part by means of a connecting means which rigidly connects these parts to each other. For this purpose, an adhesive separating material is disposed between the base part and the attachment part, said material losing its adhesive effect reversibly or irreversibly under the effect of electromagnetic radiation.

The invention relates to a method of reversibly fastening an attachment to a base with a bond that solidly connects these parts to each other, in particular also for reversibly fastening dental restorations, fillings and brackets. The invention further relates to a component for carrying out this method.

In many applications in the technical and medical fields and also in the general area of life, there is often the need to permanently connect two functionally associated parts to each other and, if necessary, to be able to nondestructively separate them again.

It is therefore an object of the present invention to propose a method that makes this possible in a simple and reliable manner.

This object is achieved according to the invention by providing between the base and the attachment an adhesion-promoting separating material that loses its adhesion-promoting effect reversibly or irreversibly under the influence of electromagnetic irradiation.

A potential application for this can be found in dentistry: Here, crowns and bridges are fastened with many different dental fastening materials as part of the prosthetic restoration of teeth. These materials involve a very heterogeneous mixture of material classes. In principal, two categories can be distinguished. These are, on the one hand, conventional inorganic cements that form ionic bonds (zinc phosphate-, polycarboxylate-, glasionomer-cements). On the other, organic materials are used. There are many requirements to be met by the bond between crown/bridge and tooth: it is not only necessary to secure the restoration against pull-off forces and shear forces; a tight seal at the crown margin should also be permanently ensured. However, temporary cements that allow removing the prosthetic restoration cannot meet the mentioned criteria. As a consequence, materials are used that make it almost impossible to remove the dental prosthesis without causing damage. If nevertheless the attempt is made to purely mechanically decement such a restoration without destroying it, it is not unusual that chipping of ceramic veneers, fractures of the built-up filling or even of the tooth occurs.

Furthermore, tooth-colored fillings (composite fillings) are connected to the remaining hard tooth tissue by adhesives. The bond with the hard tooth tissue is ensured through low-viscosity organic compounds that, in turn, form a bond with the subsequently applied plastic filling material. Polymerization takes place in a chemical manner or through electromagnetic irradiation of a suitable wavelength.

There are numerous indications for which removing the intact restoration would be desirable. In the literature, the occurrence of fractures of ceramic veneers is indicated with 3-10%. In the mouth of the patient, only inferior repairs using plastics are possible because ceramics have to be fused at high temperatures. In the case of implant-anchored restorations, a loose abutment screw can require remove of the crown/bridge. If, in the case of bridge restorations, loosening occurs at an abutment, it is often required to separate and thus to destroy the construction in the mouth. Apart from the mentioned technical indications for decementing crowns/bridges, there are also indications of biological nature. This refers to endodontic complications that require a root canal treatment of crowned teeth. If the crown cannot be removed, it is possible to simply drill through it and to subsequently perform an inferior repair of the defect with plastic, or to recondition the crown. Thus, in many cases, unnecessary costs are incurred that could be reduced by a reversible cementing method. In summary, it can be concluded that reversible cementing of dental prostheses while maintaining the condition of clinical stability is currently not possible.

Another field of application is detaching plastic, in particular, tooth-colored fillings that have to be removed from the tooth due to caries or pain. In many cases, these fillings still have, at least partially, an intact bond to the tooth that makes the removal and good optical adaptation much more difficult.

A further field of application for reversible fastening is orthodontics. In connection with fixed “braces”, so-called brackets are adhered onto the teeth. After completed treatment, these brackets are in most cases mechanically divulsed, so chipping of the enamel has to be expected as a possible complication.

In order to reduce the mechanical load when removing the brackets, devices are known that heat the bracket via an electrical heating device until the adhesive is soft. Primarily to avoid injury due to accidental contact with the hot instrument, U.S. Pat. No. 5,205,734 describes a device that heats the bracket with laser radiation. Feeding the laser light takes place through a light conductor that is integrated in the pincer-shaped device. The use of a laser wavelength is described that is absorbed by the bracket, and heating the adhesive takes place via heat conduction; also described is the use of a wavelength at which the bracket is transparent, and heating the bond point takes place through absorption of the laser light by the adhesive itself. The disadvantage of the two mentioned devices is the potential damage to the tooth and the periodontium due to excessive heat input into the irradiated area.

In order to enable that in this application—the reversible fastening of dental restorations, fillings and brackets—the fastening can be detached in a particularly gentle manner, a light absorber is used in the connecting joint, which material, by absorbing irradiated electromagnetic irradiation of a suitable wavelength, causes the bond to disintegrate.

The advantages with respect to the mentioned prior art are in particular that the irradiated energy is absorbed in the connecting joint, i.e. exactly at the point at which the energy is required for disintegrating the bond, and that in particular by using a suitable (laser) light source with high pulse output, effects other than purely thermal effects can be used for destroying the bond. Due to the irreversible damage to the fastening material, successively detaching partial areas of the bond can also be carried out, which is not possible with reversibly softening an adhesive by heating. In this manner, the irradiated (laser) light power and thus also the potential heating of the surroundings of the bond can be further reduced with regard to potential thermal damage.

Introducing the absorber can be carried out by admixing into conventional dental fastening materials or by producing a specifically developed fastening material with suitable absorbers. In order to be able to use a conventional dental fastening material without changing it, for example, so as to avoid reduced setting of the cement and to achieve a layer with higher absorber concentration and thus higher light absorption, it is possible, as an alternative, to introduce the absorber by applying an absorbing layer preferably onto the dental restoration or the bracket. Alternatively or additionally, it is possible to apply an absorbing layer onto the tooth, possibly also in connection with a dental bonding system. An advantage to be expected is the residue-free removal of the cement on the tooth.

The absorbing material should have absorption as high as possible at the wavelength or the wavelength range of the selected light source. Soot particles, for example, are suitable as absorbers, amongst others, at the wavelength 1064 nm of the Nd:YAG laser because the soot particles have high absorption in a wide spectral range.

In order to protect the surrounding area of the bond and to bring as much light as possible to the connecting joint, the wavelength range of the radiation is preferably to be selected such that the highest possible transparency for the medium to be radiographed, i.e. the dental prosthesis, the bracket, and/or the tooth, is achieved. For example, the fundamental wavelength of the Nd:YAG laser with 1064 nm has a particularly deep penetration into dentin, enamel and into ceramics.

In particular in the case of ceramic dental prostheses, the absorber can be selected for aesthetic reasons such that it causes no visible discoloration of the bond. Moreover, the absorber should be insensitive to normal ambient conditions so that over time no deterioration of the bond occurs.

The absorber and its concentration can preferably be selected such that a particularly thorough mixing with the fastening material is achieved. In the case of a layered introduction, good adhesion to the dental prosthesis, the bracket or the tooth is desirable. Also, when introducing this absorber into the bond, a thorough mixing should be targeted. Overall, if possible, the other properties of the fastening such as, for example setting of the fastening material and adhesion, should not be negatively influenced. The concentration of the absorber also serves to vary the degree of absorption so that, for example, in the case of larger layers in the connecting joint, a sufficient penetration depth of the light is achieved. This is in particular of advantage if destruction of the fastening material in the region facing in the direction opposite the irradiation direction is desired. A possible example of use is lateral irradiation of the light for removing metallic brackets and the desired penetration of light into the connecting joint up to the center of the bracket as needed for this purpose.

An advantage appears to be the use of nanoparticle whose optical properties can be adjusted in a defined manner and that can be easily mixed into the fastening materials.

For a particularly effective light-induced splitting of the polymer bonds of composite materials, it is possible to integrate a photodegradable absorber into the fastening material itself or optionally into the bonding.

The selection of the (laser) light source can determine in which manner the bond is to be destroyed. In order to avoid thermal damage to the tooth and/or the dental restoration or bracket, it appears to be advantageous to use lasers with short pulse duration, femtoseconds to several microseconds, and with high light power per pulse, so that a largely a thermal destruction of the bond takes place. For example, when using the Er:YAG laser and a suitable absorber, detaching the bond can be carried out by thermomechanical ablation. Alternatively, for example, when using a Q-switched Nd:YAG laser, microplasmas and resulting shock waves are induced at the absorbers, which shock waves finally result in an optomechanical destruction of the integrity of the fastening material. When introducing an above-mentioned photodegradable absorber into a composite, detaching the bond can take place through a photochemical process.

The (laser) light irradiation can be carried out simultaneously and over the full surface or sequentially in subareas. Sequential radiation can be carried out by manual movement or by automatic scanning.

Irradiating the bond can be carried out by a suitable applicator or by integrating the (laser) light source or the beam delivery unit in a suitable detaching tool. At the irradiation site, a homogenous beam distribution of the irradiated (laser) light is of advantage. However, other beam profiles, for example, Gaussian profiles, are also possible. In particular, if only a weakening of the bond is desired, it is also possible to carry out a multifocal irradiation with the power being concentrated on a plurality of irradiation points.

Depending on the application, a complete destruction of the bond is not always mandatory. For the best possible protection it is sufficient to simply weaken the bond prior to mechanically detaching the bond, possibly by using the known dental tools.

In terms of the device, the invention provides for a component consisting of a base, an attachment and a bond that firmly connects the base to the attachment, with, between the base and the attachment an adhesion-promoting separating material that loses its adhesion-promoting effect reversibly or irreversibly under the influence of electromagnetic irradiation.

It is advantageous here if the separating material is applied onto the joining surface of the base and/or of the attachment and/or is introduced into the bond.

Furthermore, it is recommended that the electromagnetic irradiation lies in the range of visible light and in the frequency range adjacent thereto.

In order to achieve an optimal effect, the invention proposes that the electromagnetic irradiation consists of short, high-energy pulses.

For this purpose it is useful that for emitting the electromagnetic irradiation, a Q-switched ND:YAG laser is provided.

Furthermore, it has proven to be of advantage if the attachment is transparent or at least has little absorption for the electromagnetic irradiation.

It is further of advantage here if the separating material has high absorption with respect to electromagnetic irradiation.

Another advantageous configuration is achieved if the separating material contains amorphous carbon.

It is further proposed within the context of the invention that, preferably, the separating material quantitatively reflects in the visible spectrum and absorbs in the near-infrared range.

Accordingly, it is recommended that under optomechanical interaction, the separating material undergoes a phase change with volume change and/or consistency change.

Furthermore, it is considered to be advantageous if under the influence of the electromagnetic irradiation, microplasmas with shock waves resulting therefrom are triggered in the separating material.

In the course of this and as a preferred effect, the reversible or irreversible loss of the adhesion-promoting effect of the separating material can occur as a result of the microplasmas or the shock waves.

In an advantageous use of the invention, the base can be formed from a tooth, a ground-down tooth, an implant or the like, and the attachment can be formed from a crown, a bracket, a filling, a bridge, a veneer or the like.

Further details, advantages and features of the invention arise not only from the claims but also from the following description of preferred embodiments.

In the figures:

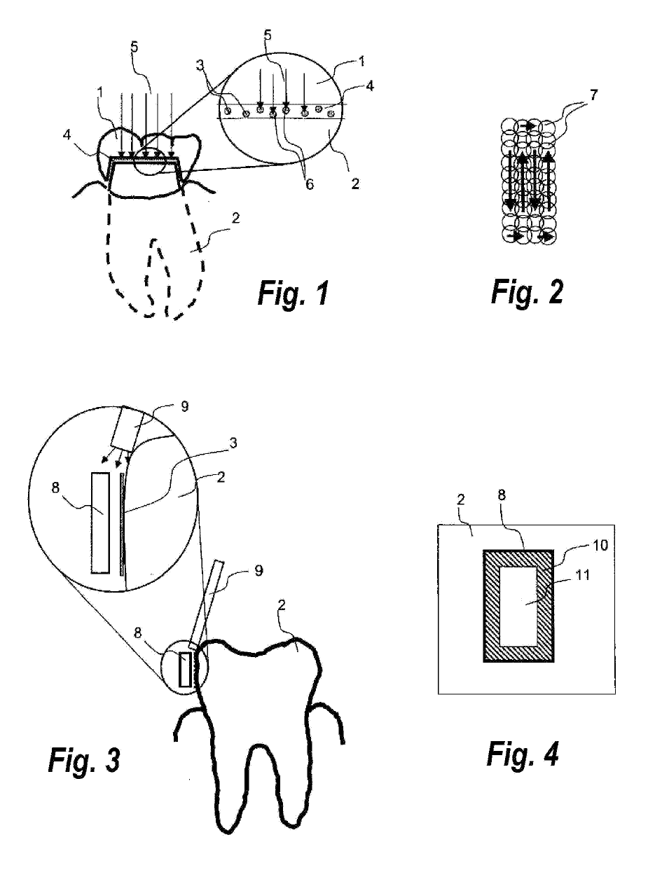

FIG. 1 shows an arrangement with a reversible bond of a crown, where the absorber is admixed with the cement,

FIG. 2 shows a possible form of the sequential irradiation of the crown for detaching the bond,

FIG. 3 shows an arrangement with a reversible bond of the bracket on the tooth, the absorber being applied in a thin layer on the tooth, and

FIG. 4 shows an arrangement with only partial disintegration of the bond at the edge of the bracket.

FIG. 1 illustrates by way of example a possible arrangement that shows the reversible fastening of a crown 1 on the tooth 2. Here, absorbers 3 are, for example, soot particles that are admixed with the fastening material located in a connecting joint 4. Detaching the bond is carried out by laser irradiation through the crown 1 with laser light 5, for example with laser light of the wavelength 1064 nm of a Q-switched Nd:YAG laser, and results in irreversible damage to the bond caused by selective light absorption 6 and by induced microplasmas in the connecting joint.

FIG. 2 shows a possible form of the sequential irradiation of the fastening position in subareas 7, where it is advantageously possible that the individual subareas 7 overlap each other. The arrows drawn in here indicate a possible movement direction of manual or automatic scanning.

FIG. 3 shows an arrangement in which a bracket 8 is fastened to the tooth 2. As an example, the absorber 3 is applied here to the tooth in layers. The irradiation for detaching the bond is carried out laterally through a light conductor 9 in the plane of the connecting joint.

FIG. 4 exemplary shows by a hatched area 10 the region underneath the bracket 7 where the bond is detached due to the lateral irradiation, whereas bond is still maintained in the central region 11. Thus, overall, only a weakening of the fastening is implemented here.

1. A method of reversibly fastening an attachment onto a base with a bond that solidly connects these parts to each other, comprising the step of:
providing between the base and the attachment an adhesion-promoting separating material that loses its adhesion-promoting effect reversibly or irreversibly under the influence of electromagnetic irradiation.

2. The method according to claim 1 for reversibly fastening dental restorations, fillings and/or brackets, which form the attachment, onto the base that is formed from a tooth, residual tooth, or implant, further comprising the step of:
introducing into the connecting joint a light absorber that, by absorbing irradiated electromagnetic irradiation of a suitable wavelength, causes disintegration of the bond.

3. The method according to claim 2, wherein the absorber is admixed with a conventional dental fastening material.

4. The method according to claim 2, wherein the absorber is admixed with a specifically developed fastening material.

5. The method according to claim 2, wherein introducing the absorber is carried out by applying an absorbing layer onto the tooth or the dental restoration or the bracket.

6. The method according to claim 4, wherein introducing the absorber is carried out in combination with a dental bonding system.

7. The method according to claim 1, wherein the wavelength range of the irradiation is selected such that an absorption as high as possible is achieved in the light-absorbing material.

8. The method according to claim 1, wherein the wavelength range of the irradiation is selected such that a transparency as high as possible is achieved for the base or attachment to be penetrated by irradiation.

9. The method according to claim 2, wherein the absorber is selected so as to cause no visible discoloration of the bond.

10. The method according to claim 1, wherein the absorber is selected so as not to be sensitive to normal ambient conditions so that over time, no deterioration of the bond occurs.

11. The method according to claim 2, wherein nanoparticles are used as an absorber.

12. The method according to claim 1, wherein a photodegradable absorber is integrated in the separating material.

13. The method according to claim 1, wherein the irradiation is carried out using pulsed lasers.

14. The method according to claim 1, wherein the pulse duration of the laser is shorter than 1 ms.

15. The method according to claim 1, wherein detaching the bond takes place by thermomechanical ablation.

16. The method according to claim 1, wherein detaching the bond takes place by optomechanical interaction.

17. The method according to claim 1, wherein detaching the bond takes place photochemically.

18. The method according to claim 1, wherein the irradiation takes place through a simultaneous, full-surface irradiation of the connecting joint.

19. The method according to claim 1, wherein the irradiation takes place sequentially in subareas.

20. The method according to claim 1, wherein the irradiation takes place through multifocal irradiation.

21. The method according to claim 1, wherein the irradiation causes only a weakening of the bond.

22. The method according to claim 1, wherein detaching the bond takes place by using known dental tools.

23. A component for carrying out the method according to claim 1, this component consisting of a base, an attachment and a bond that firmly connects the base and the attachment to each other, characterized by providing between the base and the attachment an adhesion-promoting separating material that loses its adhesion-promoting effect reversibly or irreversibly under the influence of electromagnetic irradiation.

24. The component according to claim 23, wherein the separating material is applied onto the joining surface of the base and/or the attachment to the separating material, or is introduced into the separating material.

25. The component according to claim 23, wherein the electromagnetic irradiation lies in the range of the visible light and in the frequency range adjacent thereto.

26. The component according to claim 22, wherein the electromagnetic irradiation consists of short high-energy pulses.

27. The component according to claim 26, wherein for emitting the electromagnetic irradiation, a Q-switched Nd:YAG laser is provided.

28. The component according to claim 22, wherein the attachment is transparent or at least has little absorption for electromagnetic irradiation.

29. The component according to claim 22, wherein the separating material has high absorption with respect to the electromagnetic irradiation.

30. The component according to claim 22, wherein the separating material contains amorphous carbon.

31. The component according to claim 22, wherein the separating material quantitatively reflects in the visible spectrum and absorbs in the near-infrared range.

32. The component according to claim 22, wherein under optomechanical interaction, the separating material undergoes a phase change with volume change or consistency change.

33. The component according to claim 22, wherein under the influence of the electromagnetic irradiation, microplasmas with shock waves resulting therefrom are triggered in the separating material.

34. The component according to claim 33, wherein caused by the microplasmas or the shock waves, the reversible or irreversible loss of the adhesion-promoting effect of the separating material occurs.

35. The component according to claim 22, wherein the base is formed from a tooth, a ground tooth, an implant or the like, and the attachment is formed from a crown, a bracket, a filling, a bridge, or a veneer.
